(19) United States
(12) Patent Application Publication
(10) Pub. No.: US 2025/0284012 A1
(43) Pub. Date: Sep. 11, 2025

(54) RADIATION DETECTOR STRUCTURES WITH SIDEWALL COATING AND METHODS OF FABRICATION THEREOF

(71) Applicant: REDLEN TECHNOLOGIES, INC., Saanichton (CA)

(72) Inventors: Bradley AITCHISON, Victoria (CA); Michael K. JACKSON, Vancouver (CA)

(21) Appl. No.: 19/073,884

(22) Filed: Mar. 7, 2025

Related U.S. Application Data
(60) Provisional application No. 63/563,076, filed on Mar. 8, 2024.

(51) Int. Cl. G01T 1/24

(52) U.S. Cl. CPC G01T 1/244; G01T 1/247

(57) ABSTRACT

A detector structure includes a carrier board, at least one application specific integrated circuit (ASIC) located over the carrier board, the at least one ASIC including signal processing channel circuitry, at least one radiation sensor located over a front side of the at least one ASIC, and a protective coating located over sidewalls of the at least one radiation sensor and over at least a portion of the carrier board and the at least one ASIC. In various embodiments, the detector structure including the at least one radiation sensor is assembled prior to depositing a protective coating layer over portions of the detector structure including the sidewalls of the at least one radiation sensor.

### RELATED APPLICATION

This application claims the benefit of priority to U.S. Provisional Application No. 63/563,076, filed on Mar. 8, 2024, which is incorporated by reference herein in its entirety.

### FIELD

The present disclosure relates generally to radiation detectors, and more specifically to radiation detector structures having a sidewall coating and methods of forming a sidewall coating over a radiation detector structure.

### BACKGROUND

Room temperature pixelated radiation detectors made of semiconductors, such as cadmium zinc telluride (Cd₁₋ₓZnₓTe where 0<x<1, or “CZT”), are gaining popularity for use in medical and non-medical imaging. These applications use the high energy resolution and sensitivity of the radiation detectors.

### SUMMARY

According to an aspect of the present disclosure, a detector structure includes a carrier board, at least one application specific integrated circuit (ASIC) located over the carrier board, the at least one ASIC including signal processing channel circuitry, at least one radiation sensor located over a front side of the at least one ASIC, the at least one radiation sensor having a front side and a back side, wherein the back side of the at least one radiation sensor faces the front side of the at least one ASIC; and a protective coating located over sidewalls and at least a portion of the back side of the at least one radiation sensor and over at least a portion of the at least one ASIC and over at least a portion of the carrier board.

According to another aspect of the present disclosure, a method of fabricating a detector structure includes assembling a detector structure by mounting at least one ASIC over a front side of a carrier substrate and at least one radiation sensor over a front side of the at least one ASIC, and forming a protective coating over at least a portion of the assembled detector structure including over sidewalls of the at least one radiation sensor.

Further embodiments include X-ray imaging systems including a radiation source configured to emit an X-ray beam, and a plurality of above-described detector structures that form a continuous detector surface and that are configured to receive the X-ray beam from the radiation source through an intervening space configured to contain an object therein.

### BRIEF DESCRIPTION OF THE DRAWINGS

FIG. 1A is a functional block diagram of an X-ray imaging system in accordance with various embodiments of the present disclosure.

FIG. 1B is a schematic illustration of an application specific integrated circuit (ASIC) configured to count X-ray photons detected in each pixel detector within a set of energy bins according to various embodiments of the present disclosure.

FIG. 2A is a rear perspective view of a detector array for a computed tomography (CT) X-ray imaging system according to various embodiments of the present disclosure.

FIG. 2B is a perspective view of a CT X-ray imaging system illustrating the orientation of the detector array with respect to an X-ray source and a patient being imaged according to various embodiments of the present disclosure.

FIG. 3A is a vertical cross-sectional view of a radiation detector unit according to one embodiment of the present disclosure.

FIG. 3B is a side view of an alternative configuration of a radiation detector unit according to various embodiments of the present disclosure.

FIG. 4 is a perspective view of a detector module including a plurality of radiation detector units mounted to a frame bar according to various embodiments of the present disclosure.

FIG. 5 is a top view of a detector array including a plurality of detector modules according to various embodiments of the present disclosure.

FIG. 6A is a side cross-section view of a radiation detector unit including a carrier board, an ASIC mounted over the front side of the carrier board, and a plurality of radiation sensors mounted over the front side of the ASIC according to various embodiments of the present disclosure.

FIG. 6B is a side cross-section view of the radiation detector unit with a mask formed over select portions of the radiation detector unit according to various embodiments of the present disclosure.

FIG. 6C is a side cross-section view of the radiation detector unit with a protective coating deposited over exposed surfaces of a radiation detector unit according to various embodiments of the present disclosure.

FIG. 6D is a side cross-section view of the radiation detector unit with a protective coating following the removal of the mask according to various embodiments of the present disclosure.

FIG. 6E is a side cross-section view of a radiation sensor according to an alternative embodiment.

FIG. 7 is a side cross-section view of the radiation detector unit with a protective coating according to another embodiment of the present disclosure.

FIG. 8 is a flow diagram illustrating a method of fabricating a detector structure according to various embodiments of the present disclosure.

### DETAILED DESCRIPTION

Embodiments of the present disclosure provide detector arrays for ionizing radiation, the various aspects of which are described herein with reference to the drawings.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims. Any reference to claim elements in the singular, for example, using the articles “a,” “an,” or “the” is not to be construed as limiting the element to the singular. The terms “example,” “exemplary,” or any term of the like are used herein to mean serving as an example, instance, or illustration. Any implementation described herein as an “example” is not necessarily to be construed as preferred or advantageous over another implementation. The drawings are not drawn to scale. Multiple instances of an element may be duplicated where a single instance of the element is illustrated, unless absence of duplication of elements is expressly described or clearly indicated otherwise.

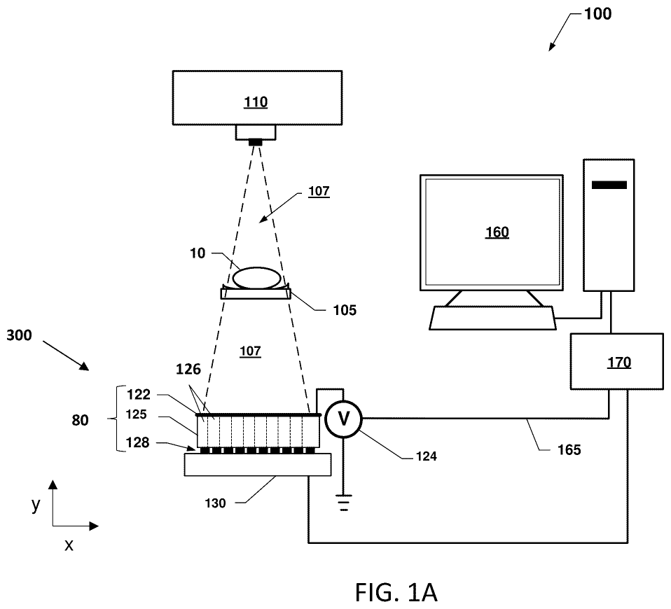

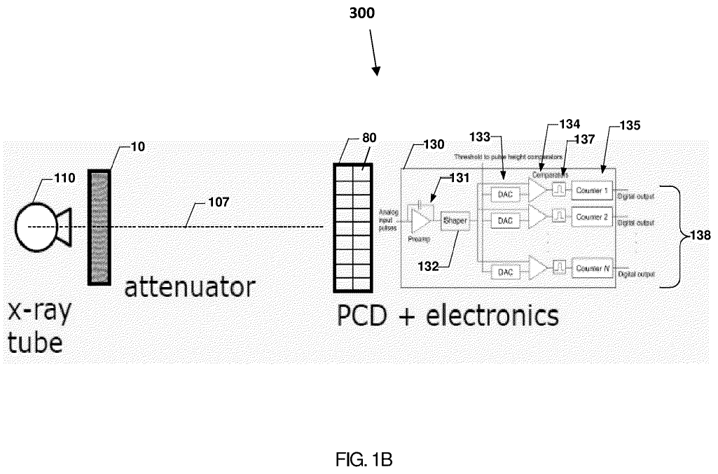

FIG. 1A is a functional block diagram of an X-ray imaging system 100 in accordance with various embodiments. The X-ray imaging system 100 may include an X-ray source 110 (i.e., a source of ionizing radiation), and an energy discriminating photon counting radiation detector array 300. The X-ray imaging system 100 may additionally include a patient support structure 105, such as a table or frame, which may rest on the floor and may support an object 10 to be scanned. In some embodiments, the object 10 may be a biologic subject (i.e., a human or animal patient). The support structure 105 may be stationary (i.e., non-moving) or may be configured to move relative to other elements of the X-ray imaging system 100, such as the X-ray source. For example, in a non-destructive testing imaging system, the support structure 105 may comprise a moving belt or web which supports the object 10. The object 10 may laterally translated by the moving belt or web past a stationary X-ray source 110, while the stationary detector array 300 is located under the belt or web. The object 10 may comprise food, baggage, manufactured products, or any other object that is subject to non-destructive testing to determine the object's composition (e.g., whether the food contains impurities), contents (e.g., contents of baggage), and/or defects (e.g., defects in manufactured products).

The X-ray source 110 may be mounted to a gantry (e.g., for CT imaging) or another support, and may move or remain stationary (e.g., in non-destructive testing) relative to the object 10. The X-ray source 110 is configured to deliver ionizing radiation to the radiation detector array 300 by emitting an X-ray beam 107 toward the object 10 and the radiation detector array 300. After the X-ray beam 107 is attenuated by the object 10, the beam of radiation 107 is received by the radiation detector array 300. In an alternative mode, the X-ray beam is diffracted by the object 10, the beam of radiation 107 is received by the radiation detector array 300.

The radiation detector array 300 may include one or more radiation sensors 80 coupled to detector read-out circuitry 130. Each radiation sensor 80 may be controlled by a high voltage bias power supply 124 that selectively creates an electric field between an anode 128 and cathode 122 pair coupled thereto. In one embodiment, each radiation sensor 80 includes a plurality of anodes 128 (e.g., one anode per pixel) and one common cathode 122 electrically connected to the power supply 124 and facing the X-ray source 110. Each radiation sensor 80 may include a detector material 125, such as a semiconductor material disposed between the anode 128 and cathode 122 and thus configured to be exposed to the electrical field therebetween. The semiconductor material may comprise any suitable semiconductor material for detecting X-ray radiation disposed between the anode 128 and cathode 122 and thus configured to be exposed to the electrical field therebetween. In various embodiments, the semiconductor material of the radiation sensor(s) 80 may comprise a II-VI semiconductor material, such as cadmium telluride, cadmium zinc telluride (i.e., CdZnTe or “CZT”), cadmium selenide telluride, and cadmium zinc selenide telluride. Other suitable semiconductor materials are within the contemplated scope of disclosure. These materials may include a “High Z” element.

The detector read-out circuitry may include one or more application specific integrated circuits (ASICs) 130. Each ASIC 130 may be coupled to one or more radiation sensors 80 and may receive signals (e.g., charge or current) from the anodes 128 of the radiation sensor(s) 80. Alternatively, multiple ASICs 130 may be coupled to one radiation sensor 80. Each ASIC 130 may be configured to provide data to and by controlled by a control unit 170. Each of the radiation sensors 80 may be segmented or configured into a large number of small “pixel” detectors 126. In various embodiments, the pixel detectors 126 of the radiation sensors 80 and the ASIC(s) 130 are configured to output data that includes counts of photons detected in each pixel detector 126 in each of a number of energy bins. Thus, radiation detector arrays 300 of various embodiments may provide both two-dimensional detection information regarding where photons were detected, thereby providing image information, and measurements of the energy of the detected X-ray photons. A radiation detector array 300 that is capable of measuring the energy of the X-ray photons impinging on the array 300 may be referred to as an energy-discriminating radiation detector array 300.

The control unit 170 may be configured to synchronize the X-ray source 110, the read-out ASIC(s) 130, and the high voltage bias power supply 124. The control unit 170 may be coupled to and operated from a computing device 160. Alternatively, the computing device 160 and the control unit 170 may be integrated together as one device.

In some embodiments, the X-ray imaging system 100 may be a computed tomography (CT) imaging system. The CT imaging system 100 may include a gantry (not shown in FIG. 1A), which may include a moving part, such as a circular, rotating frame with the X-ray source 110 mounted on one side and the radiation detector array 300 mounted on the other side. The radiation detector array 300 may have a curved shape along its long axis (i.e., the x-axis direction in FIG. 1A) such that each of the pixel detectors 126 along the length of the radiation detector may face towards the focal spot of the X-ray source 110. The gantry may also include a stationary (i.e., non-moving) part, such as a support, legs, mounting frame, etc., which rests on the floor and supports the moving part. The X-ray source 110 may emit a fan-shaped or cone-shaped X-ray beam 107 as the X-ray source 110 and the radiation detector array 300 rotate on the moving part of the gantry around the object 10 to be scanned. After the X-ray beam 107 is attenuated by the object 10, the X-ray beam 107 is received by the radiation detector array 300. The curved shape of the radiation detector array 300 may allow the CT imaging system 100 to most effectively reject radiation scattered by the object 10.

For each complete rotation of the X-ray source 110 and the radiation detector array 300 around the object 10, one cross-sectional slice of the object 10 may be acquired. As the X-ray source 110 and the radiation detector array 300 continue to rotate, the radiation detector array 300 may take numerous snapshots called “views”. The X-ray source 110 and the detector array 300 may slowly move relative to the object (e.g., patient) 10 along a horizontal direction (i.e., into and out of the page in FIG. 1A) so that the detector array 300 may capture incremental cross-sectional profiles over a region of interest (ROI) of the object 10, which may include the entire object 10. The data acquired by the radiation sensor(s) 80 and output by the read-out ASIC(s) 130 may be passed along to the computing device 160 that may be located remotely from the radiation detector array 300 via a connection 165. The connection 165 may be any type of wired or wireless connection. If the connection 165 is a wired connection, the connection 165 may include a slip ring electrical connection between any structure (e.g., gantry) supporting the radiation detector array 300 and a stationary support part of the support structure, which supports any part (e.g., a rotating ring). If the connection 165 is a wireless connection, the radiation detector array 300 may contain any suitable wireless transceiver to communicate data with another wireless transceiver that is in communication with the computing device 160. The computing device 160 may include processing and imaging applications that analyze each profile obtained by the radiation detector array 300, and a full set of profiles may be compiled to form a three-dimensional computed tomographic (CT) reconstruction of the object 10 and/or two-dimensional images of cross-sectional slices of the object 10.

Various alternatives to the design of the X-ray imaging system 100 of FIG. 1A may be employed to practice embodiments of the present disclosure. X-ray imaging systems may be designed in various architectures and configurations. For example, an X-ray imaging system may have a helical architecture. In a helical X-ray imaging scanner, the X-ray source 110 and radiation detector array 300 are attached to a freely rotating gantry. During a scan, the support structure (e.g., table) 105 moves the object 10 smoothly through the scanner, or alternatively, the X-ray source 110 and detector array 300 may move along the length of the object 10, creating helical path traced out by the X-ray beam. Alternatively, in an orbital X-ray imaging scanner, the object 10 may remain stationary while the gantry rotates completely or partially around the object 10 (e.g., to image a heart or a brain in one revolution). Slip rings may be used to transfer power and/or data on and off the rotating gantry. In other embodiments, the X-ray imaging system may be a tomosynthesis X-ray imaging system. In a tomosynthesis X-ray scanner, the gantry may move in a limited rotation angle (e.g., between 15 degrees and 60 degrees) in order to detect a cross-sectional slice of the object 10. The tomosynthesis X-ray scanner may be able to acquire slices at different depths and with different thicknesses that may be reconstructed via image processing. Alternatively, the X-Ray imaging system 100 may be a non-destructive testing system.

FIG. 1B illustrates components of an X-ray imaging system, including components within the ASIC 130 configured to count X-ray photons detected in each pixel detector 126 within a set of energy bins. As used herein, the terms “energy bin” and “bin” refer to a particular range of measured photon energies between a minimum energy threshold and a maximum energy threshold. For example, a first bin may refer to counts of photons determined to have an energy greater than a threshold energy (referred to as a trigger threshold, e.g., 20 keV) and less than 40 keV, while a second bin may refer to counts of photons determined to have an energy greater than 40 keV and less than 60 keV, and so forth.

X-rays 107 from an X-ray source (e.g., X-ray tube) 110 may be attenuated by a target (e.g., an object 10, such as a human or animal patient) before interacting with the radiation detector material within the pixelated detector array 300. An X-ray photon interacting (e.g., via the photoelectric effect) with a pixelated radiation detector material generates an electron cloud within the material that is swept by an electric field to the anode electrode 128. The charge gathered on the anode creates a signal that is integrated by a charge sensitive amplifier (CSA) 131. There may be a CSA 131 for each pixel detector 126 (e.g., for each anode 128) within the pixelated X-ray detector array 300. The voltage of the CSA output signal may be proportional to the energy of the X-ray photon. The output signal of the CSA may be processed by an analog filter or shaper 132.

The filtered output may be connected to the inputs of a number of analog comparators 134, with each comparator connected to a digital-to-analog converter (DAC) 133 that inputs to the comparator a DAC output voltage that corresponds to the threshold level defining the limits of an energy bin. The detector circuitry 130 may be configured so that after the CSA voltage has stabilized (after the dead time), that voltage may be between two voltage thresholds set by two DACs 133, which determines the output of the comparators 134. Outputs from the comparators 134 may be processed through decision gates 137, with a positive output from a comparator 134 corresponding to a particular energy bin (defined by the DAC output voltages) resulting in a count added to an associated counter 135 for the particular energy bin. Periodically, the counts in each energy bin counter 135 are output as signals 138 to the control unit 170.

Other suitable configurations for the read-out electronics of the ASIC 130 are within the contemplated scope of disclosure. For example, in some configurations, the analog voltage signals from the CSA may be converted to digital signals using an analog-to-digital converter (ADC) prior to being sorted into the respective energy bins.

The detector array 300 of an X-ray imaging system may include an array of radiation detector elements, referred to herein as pixel detectors. The signals from the pixel detectors may be processed by a pixel detector circuit (e.g., an above-described ASIC 130), which may sort detected photons into energy bins based on the energy of each photon or the voltage generated by the received photon. When an X-ray photon is detected, its energy is determined and the X-ray photon count for its associated energy bin is incremented. For example, if the detected energy of an X-ray photon is 24 kilo-electron-volts (keV), the X-ray photon count for the energy bin of 20-40 keV may be incremented. The number of energy bins may be three or more, such as four to twelve. In an illustrative example, an X-ray photon counting detector may have four energy bins: a first bin for detecting photons having an energy between 20 keV and 40 keV, a second bin for detecting photons having an energy between 40 keV and 60 keV, a third bin for detecting photons having an energy between 60 keV and 90 keV, and a fourth bin for detecting photons having an energy above 90 keV (e.g., between 90 keV and 120 keV). The greater the total number of energy bins, the better the material discrimination. The total number of energy bins and the energy range of each bin may be selectable by a user, such as by adjusting the threshold levels defining the limits of the respective energy bins in the read-out ASIC 130 as shown in FIG. 1B.

In various embodiments, a detector array 300 for an X-ray imaging system 100 as described above may include a plurality of pixel detectors 126 extending over a two-dimensional (2D) detector array surface. A typical radiation detector array 300 may include an array of individual radiation sensors 80 arranged side-by-side to provide the 2D detector array surface. The radiation sensors 80 may be located sufficiently close to each other to treat the 2D detector surface as essentially continuous, even though there are small gaps present between adjacent radiation sensors 80. Each radiation sensor 80 may comprise a semiconductor detector material plate 125, a continuous cathode electrode 122 located on a first side of the semiconductor detector material plate 125, and a plurality of anode electrodes 128 located on a second side of the semiconductor detector material plate 125. Each of the pixel detectors 126 comprises one the plurality of anode electrodes 128 and portions of the continuous cathode electrode 122 and the semiconductor detector material plate 125 overlying the one of the plurality of anode electrodes 128.

The detector array 300 (which is also referred herein as a detector module system (DMS)) may further include a modular configuration including a plurality of detector modules, where each detector module may include at least one above-described radiation sensor 80, at least one ASIC 130 (also known as a read-out integrated circuit (ROIC)) electrically coupled to the at least one radiation sensor 80, and a module circuit board. The module circuit board may support transmission of electrical power, control signals, and data signals between the module circuit board and the at least one ASIC 130 and the at least one radiation sensor 80 of the detector module, and may further support transmission of electrical power, control signals, and data signals between the module circuit board and the control unit 170 of the X-ray imaging system 100, other module circuit boards of the detector array, and/or a power supply for the detector array. A plurality of detector modules may be assembled on a common support structure, such as a detector array frame, to form a detector array 300.

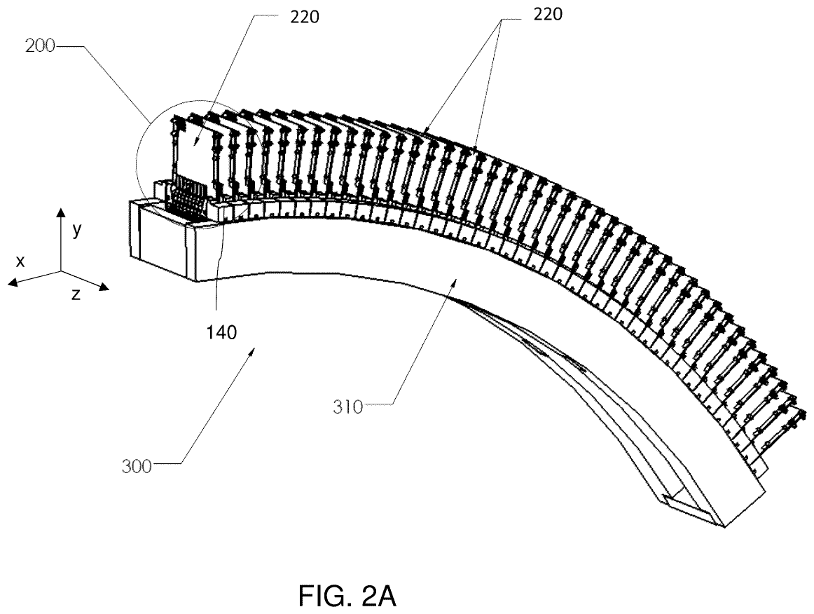

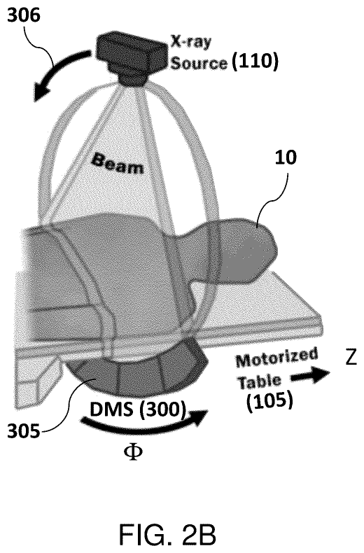

FIG. 2A is a rear perspective view of a detector array 300 for a computed tomography (CT) X-ray imaging system according to various embodiment of the present disclosure. The detector array 300 in this embodiment includes multiple detector modules 200 mounted on a detector array frame 310. The detector array frame 310 may be configured to provide attachment of a row of detector modules 200 such that physically exposed surfaces of the radiation sensors 80 of the detector modules 200 collectively form a curved detection surface located within a cylindrical surface. The multiple detector modules 200 may be assembled such that radiation sensors attached to neighboring detector modules 200 abut each other, i.e., make direct surface contact with each other and/or include a gap between adjacent radiation sensors that is less than 3 mm, and/or less than 2 mm, and/or less than 1 mm in the x-direction. In some embodiments, the detector modules 200 may be mounted to the detector array frame 310 by attaching frame bars 140 of the detector modules 200 to the detector array frame 310 using suitable mechanical fasteners. The radiation sensors and ASICs 130 of each module 200 may be mounted over a first (i.e., front) surface of the frame bar 140. Each module 200 may also include a module circuit board 220 extending away from a rear surface of the frame bar 140. Major surfaces of the module circuit boards 220 of the detector modules 200 may face each other in the detector array 300.

FIG. 2B is a perspective view of a CT X-ray imaging system 100 illustrating the orientation of the detector array 300 with respect to an X-ray source 110 and an object (e.g., patient) 10 being imaged according to various embodiments of the present disclosure. Referring to FIG. 2B, the X-ray source 110 and the detector array 300 (e.g., DMS) may rotate around the object 10 and the support structure (e.g., motorized table) 105 along the direction of arrow 306 to obtain cross-sectional image profiles (or “slices”) of the object 10. The X-ray source 110 and the detector array 300 may also be translated relative to the object 10 (e.g., by moving the support structure 105 and the object 10 with respect to the X-ray source 110 and the detector array 300 and/or by moving the X-ray source 110 and the detector array 300 along the length of the object 10) along a horizontal direction to obtain cross-sectional image “slices” of different portions of the object 10. The direction of the horizontal movement of the X-ray source 110 and the detector array 300 relative to the object 10 may be referred to as the “Z-axis” direction, which may be parallel to the axis of rotation of the X-ray source 110 and the detector array 300 around the object 10. As discussed above, the detector array 300 may also have a curved shape along the direction in which the X-ray source 110 and the detector array 300 rotate around the object 10. The pixel detectors 126 of the detector array 300 may be arranged in multiple columns and rows of pixel detectors, where each column may extend along the Z-axis direction, and each row may extend along the direction of rotation 306 (e.g., angular Φ direction) of the detector array 300 around the object 10. Accordingly, the location of each pixel detector 126 within the detector array 300 may be defined by a unique row and column pair, where the location of the pixel detector 126 within a given column may be defined by its location along the Z-axis direction, and the location of the pixel detector within a given row may be defined by the azimuth angle Φ of a line segment extending between the pixel detector 126 and the focal spot of the X-ray source 110, where all pixel detectors 126 within the same column may have the same azimuth angle Φ. The detector array 300 shown in FIG. 2B may be similar to the detector array 300 described above with reference to FIG. 2A. The detector array 300 may further include a suitable housing or enclosure 305 that encloses and protects the module circuit boards 220.

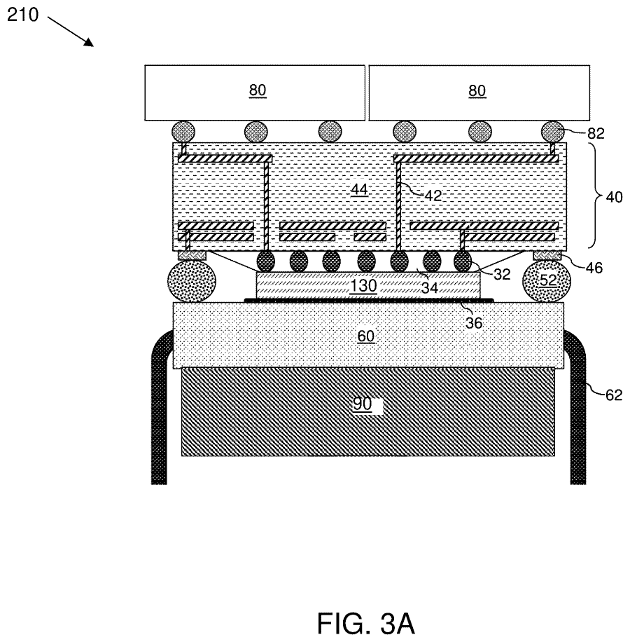

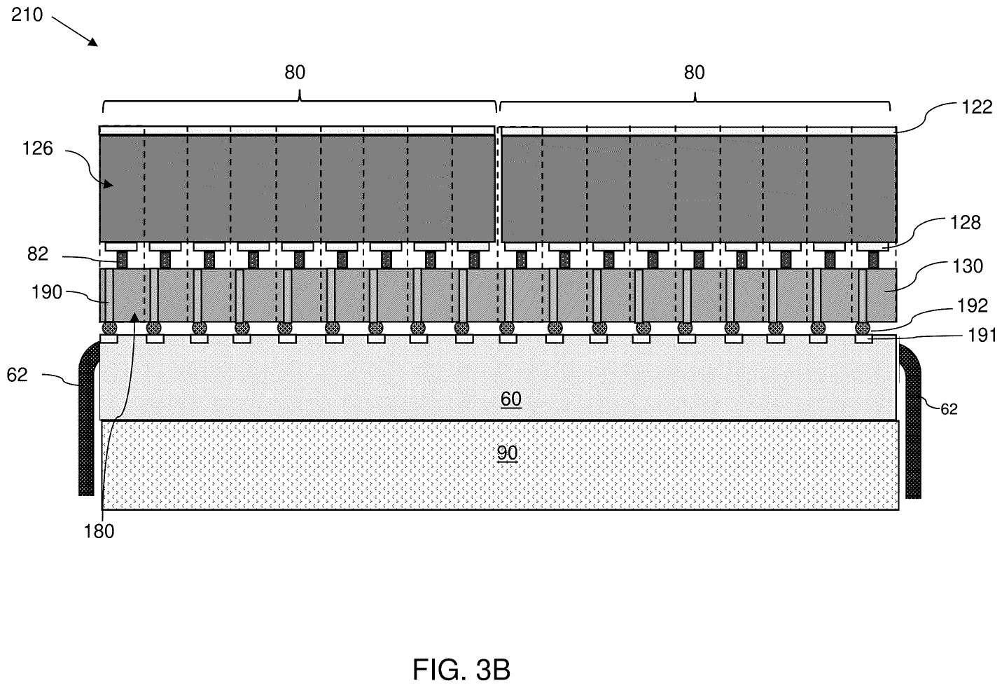

In some embodiments, each of the detector modules 200 of the detector array 300, such as the detector array 300 shown in FIGS. 2A and 2B may be constructed from a set of radiation detector units, which may also be referred to as “mini-modules” or “submodules.” In some embodiments, each of the radiation detector units may include one or more radiation sensors 80 coupled to a single ASIC 130. FIG. 3A is a vertical cross-sectional view of a radiation detector unit 210 according to one embodiment of the present disclosure. Referring to FIG. 3A, the radiation detector unit 210 includes a pair of above-described radiation sensors 80, an ASIC 130, and an interposer 40 disposed between the radiation sensors 80 and the ASIC 130. The interposer 40 includes an insulating interposer matrix 44, which may include semiconductor, glass, polymer (e.g., printed circuit board insulating laminate) or ceramic material, and a plurality of metal interconnect structures 42 embedded within the insulating interposer matrix 44. Bonding pads (not expressly shown) may be located on the front side and the backside of the interposer 40 and may be electrically coupled to the metal interconnect structures 42. As used herein, the “front side” of elements refers to the side that faces the incoming radiation, and the “backside” of elements refers to the side that is the opposite side of the front side.

The ASIC 130 may interface with external components through bonding pads that are located on the front side of the ASIC 130. The bonding pads may include input pads, output pads, and power pad. The bonding pad(s) of the ASIC 130 can be arranged as an array, such as a rectangular array. At least a portion of the bonding pads on the backside of the interposer 40 may have the same periodicity as the bonding pads on the front side of the ASIC 130.

Each of the radiation sensors 80 may have bonding pads located on the backside of the radiation sensor 80. The bonding pads on the backside of the radiation sensors 80 may be arranged as an array, such as a rectangular array. The front side bonding pads of the interposer 40 may have the same periodicity as the periodicity of bonding pads on the backside of the radiation sensors 80.

Referring again to FIG. 3A, the ASIC 130 may be mounted to the backside of the interposer 40 through an array of first bonding structures 32, such as solder balls or copper pillars. Specifically, the array of first bonding structures 32, may be bonded to a respective array of a bonding pads (not shown for clarity) on the front side of the ASIC 130 and an array of backside bonding pads of the interposer 40 employing a flip-chip bonding process (e.g., a C4 bonding process and/or a thermo-compression process in embodiments using copper pillar bonding structures). An insulating matrix 34 may be formed around the array of first bonding structures 32 to structurally reinforce the array of first bonding structures 32. While a configuration in which one ASIC 130 is bonded to the backside of the interposer 40 is illustrated herein, two or more ASICs 130 may be bonded to the backside of the interposer 40 in some embodiments. At least one radiation sensor 80 may be bonded to the front side of the interposer 40 via bonding material portions 82. In some embodiments, the bonding material portions 82 may include a low temperature solder material or conductive epoxy. In one embodiment, the at least one radiation sensor 80 includes a pair of radiation sensors 80 having a respective rectangular shape and adjoined to each other with no gap or with a gap less than 3 mm, and/or less than 2 mm, and/or less than 1 mm. X-ray photon detection signals from the radiation sensors 80 may be transmitted to the ASIC 130 via the interposer 40. The ASIC 130 may be configured to convert event detection signals from the at least one radiation sensor 80 to digital detection signals, which can include the pixel location and the energy range of the detected radiation.

The radiation detector unit 210 may further include a carrier board 60 and at least one flex cable assembly 62, which are configured to route power supply to the ASIC 130 and to the at least one radiation sensor 80, control signals to the ASIC 130, and data signals (e.g., digital detection signals) generated by the ASIC 130 and transmitted through the interposer 40. One end of each flex cable assembly 62 may be attached to a respective side of the carrier board 60, and another end of each flex cable assembly may be connected to a module circuit board 220 as shown in FIG. 2. The carrier board 60 may be a printed circuit board including an insulating substrate and printed interconnection circuits. A thermally conductive paste 36, such as a silver paste layer, may be provided between the backside of the ASIC 130 and the front side of the carrier board 60. An array of second solder balls 52 may each be bonded to a bonding pad 46 on the backside of the interposer 40 and a corresponding bonding pad (not expressly shown in FIG. 3A) on the front side of the carrier board 60. The second solder balls 52 may be located around and laterally spaced away from peripheral side surfaces of the ASIC 130. Each flex cable assembly 62 may include signal wires and power wires. The signal wires are configured to transmit the electronic detection signals and control signals, and the power wires are configured to provide electrical power to the interposer 40, which distributes the electrical power to the ASIC 130 and the radiation sensor(s) 80. In some embodiments, the flex cable assembly 62 can be more flexible (i.e., can bend with a lower application of force) than the carrier board 60.

The radiation sensors 80, the interposer 40, the ASIC 130 and the carrier board 60 may be mounted to a supporting substrate (e.g., a block) 90 as shown in FIG. 3A. The supporting substrate may include a high thermal conductivity material such as a metal (e.g., aluminum, copper, etc.). The supporting substrate 90 may function as a heat sink for the radiation detector unit 210. The supporting substrate 90 may be attached to the backside of the carrier board 60 using a thermally conductive adhesive such as a thermally conductive paste, and/or by mechanical connection structures (such as snap-in connectors, screws, and/or bolts and nuts).

FIG. 3B is a vertical cross-section view of an alternative configuration of a radiation detector unit 210 according to an alternative embodiment of the present disclosure. In this embodiment, a pair of radiation sensors 80 is directly mounted to an ASIC 130 via a plurality of bonding material portions 82. Referring to FIG. 3B, each radiation sensor 80 may include an above-described detector material 125 having at least one cathode electrode 122 on a front side of the radiation sensor 80 and a plurality of anode electrodes 128 on a back side of the radiation sensor 80 defining an array of pixel detectors 126 as described above. Each radiation sensor 80 may be directly mounted to the front side of the ASIC 130 via a plurality of bonding material portions 82. In other words, each radiation sensor 80 may be mechanically and electrically coupled to the ASIC 130 via the plurality of bonding material portions 82, and no interposer 40 or similar intervening structural component for routing of electrical signals between the radiation sensors 80 and the ASIC 130 is located between the back side of each of the radiation sensors 80 and the front side of the ASIC 130. Such a configuration may be referred to as a “direct attach” radiation detector unit 210. Exemplary embodiments of “direct attach” radiation detector units 210 and detector modules 200 are described, for example, in U.S. Provisional Patent Application No. 63/380,769, filed on Oct. 25, 2022, and U.S. patent application Ser. No. 18/158,695, filed on Jan. 24, 2023, the entire teachings of both of which are incorporated by reference herein for all purposes.

The plurality of bonding material portions 82 may be arranged in an array, such as a rectangular array, having the same periodicity as the periodicity of the anode electrodes 128 on the back sides of the radiation sensors 80. Thus, each bonding material portion 82 may electrically couple a respective anode electrode 128 of a radiation sensor 80 to the front side of the ASIC 130. In one non-limiting embodiment, the bonding material portions 82 may be composed of a conductive epoxy. Other suitable bonding materials, such as a low temperature solder material coupled with under bump metallization on the anode electrodes 128, may be utilized to mount the radiation sensor 80 to the front side of the ASIC 130. An optional underfill material (not shown in FIG. 3B) may be provided in the space between the back side surface of the radiation sensors 80 and the front side surface of the ASIC 130 and laterally surrounding the bonding material portions 82. The underfill material may include a suitable insulating material, such as an insulating epoxy material or an inorganic dielectric material, such as TiO₂ or mixtures thereof

In the embodiment illustrated in FIG. 3B, a pair of radiation sensors 80 are mounted to the front side of the ASIC 130, although it will be understood that in other embodiments, a single radiation sensor 80 or more than two radiation sensors 80 may be mounted to the front side of the ASIC 130. In some embodiments, the horizontal dimensions of the ASIC 130 may be substantially equal to or slightly smaller than the combined dimensions of the one or more radiation sensors 80 mounted thereto along the corresponding horizontal directions. Thus, each pixel detector 126 of the radiation sensor(s) 80 may overlie a corresponding pixel region 180 of the ASIC 130. In some embodiments, the ASIC 130 and each of the radiation sensors 80 mounted thereto may have a rectangular periphery. This may enable any of the four peripheral sides of the radiation detector unit 210 to be abutted against a peripheral side of an adjacent radiation detector unit 210 upon assembly of multiple radiation detector units 210 in a detector array 300.

The radiation detector unit 210 of FIG. 3B may further include a carrier board 60 that is configured to route power supply to the ASIC 130 and to the at least one radiation sensor 80, control signals to the ASIC 130, and data signals (e.g., digital detection signals) generated by the ASIC 130. One or more cables 62, such as a flex cable assembly, may be attached to a respective side of the carrier board 60, and another end of each cable may be connected to the above-described module circuit board 220. The carrier board 60 may be a printed circuit board including an insulating substrate and printed interconnection circuits. In various embodiments, the ASIC 130 may be disposed over the carrier board 60 such that the back side of the ASIC 130 may contact the front side of the carrier board 60.

Optionally, a plurality of through-substrate vias (TSVs) 190 may be provided in the ASIC 130. The TSVs 190 may include an electrically conductive material (e.g., a metal material, such as copper) that extends between the front side and the back side of the ASIC 130. In embodiments in which the ASIC 130 may be formed on and/or in a silicon substrate, the TSVs 190 may also be referred to as “through-silicon vias.”

Accordingly, electrical connections between the carrier board 60 and the ASIC 130 may be made through the back side of the ASIC 130 via the plurality of TSVs 190. In particular, each of the TSVs 190 may electrically contact a conductive trace 191 located on the front side of the carrier board 60, as schematically illustrated in FIG. 3B. This may obviate the need for wire bond and/or interposer connections between the front side of the carrier board 60 and the front side of the ASIC 130, which may help to minimize the footprint of the radiation detector unit 210. In some embodiments, the TSVs 190 may be connected to the metal interconnect features 191 on the carrier board 60 via a plurality of bonding material portions 192, which may include, for example, solder balls. In various embodiments, outer periphery of the carrier board 60 may not extend beyond the outer periphery of the ASIC(s) 130 and radiation sensor(s) 80 located over the carrier board 60 so as to provide a radiation detector unit 210 that is buttable on all four sides.

In other embodiments, a portion of the ASIC 130 may extend beyond the outer periphery of the radiation sensor(s) 80 and a portion of the carrier board 60 may extend beyond the outer periphery of the ASIC 130. A plurality of wire bond connections may extend between the front side of the carrier board 60 and the front side of the ASIC 130, as is described and illustrated in the above-referenced U.S. patent application Ser. No. 18/158,695. The wire bond connections between the carrier board 60 and the ASIC 130 may be in addition to, or may be in lieu of, electrical connections between the front side of the carrier board 60 and the back side of the ASIC 130 via TSVs 190 as described above.

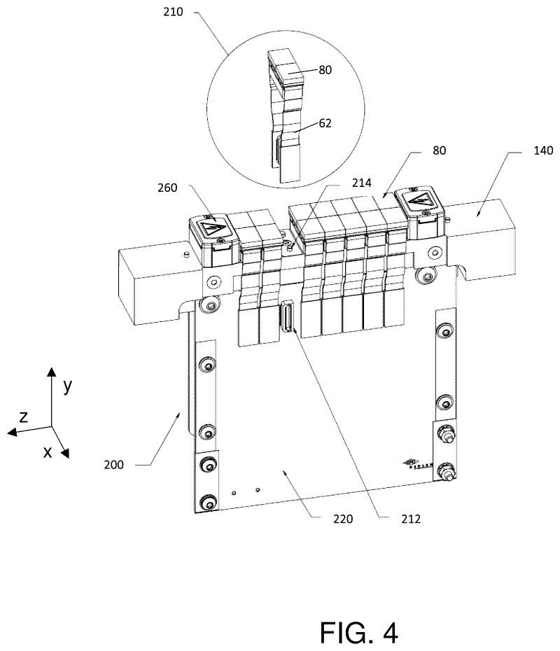

FIG. 4 is a perspective view of a detector module 200 including a plurality of above-described radiation detector units 210 mounted to an above-described frame bar 140. A column of radiation detector units 210 may be mounted to the front side of the frame bar 140. Engagement features 214 may optionally be provided on the front side of the frame bar 140 that may mate with corresponding engagement features (not shown) on the backside of the supporting substrate (e.g., carrier board 60) of each of the radiation detector units 210. End holders 260 may optionally be located at either end of the column of radiation detector units 210. A module circuit board 220 may be mechanically coupled to the frame bar 140 by suitable mechanical fastener(s). Each radiation detector unit 210 of the detector module may be electrically coupled to the module circuit board 220 by a flex cable assembly 62. In the embodiment shown in FIG. 4, the module circuit board 220 may include board-side connectors 212, where each board-side connector 212 may be connected to a connector, such as a snap-in connector 66, of a respective flex cable. In the embodiment shown in FIG. 4, each detector module 200 includes a column of eight (8) radiation detector units 210, each including a pair of radiation sensors 80 mounted over an ASIC 130. It will be understood that other configurations for the detector modules 200 are within the scope of this disclosure.

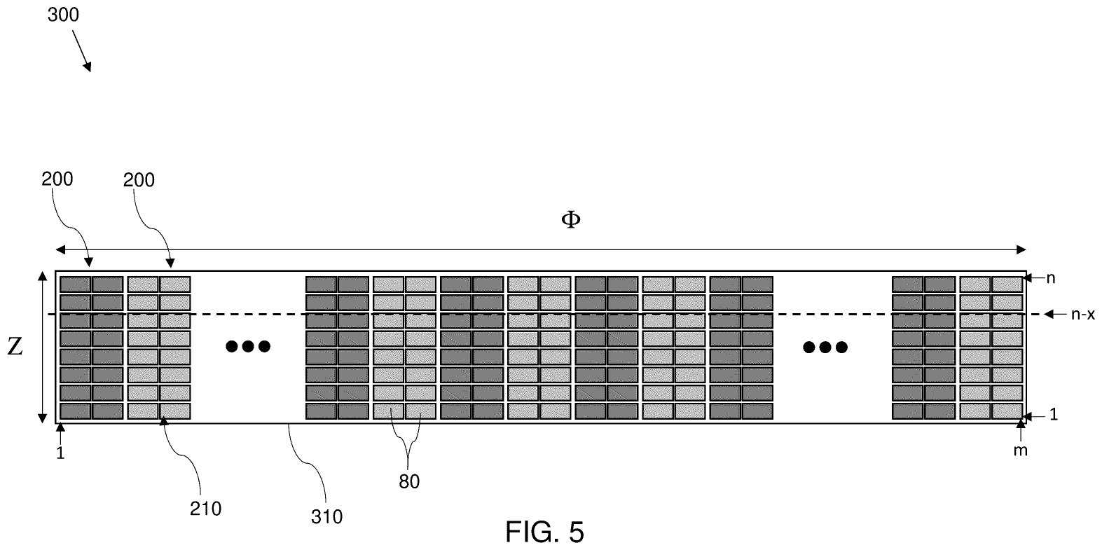

FIG. 5 is a top view of a detector array 300 including a plurality of detector modules 210 according to comparative embodiments of the present disclosure. Referring to FIG. 5, the detector array 300 may include a plurality of above-described detector modules 200 mounted on a detector array frame 310 to provide a continuous detector surface. For clarity of illustration, adjacent detector modules 200 are depicted in alternating shading in FIG. 5. The detector surface may include an m x n array of pixel detectors 126 including n rows of pixel detectors 126 extending along the Φ direction and m columns of pixel detectors 126 extending along the Z-axis direction, where m and n are integers.

Each detector module 200 of the detector array 300 may include a plurality of radiation detector units 210 mounted on a common support. In the embodiment shown in FIG. 5, each module includes a column of eight (8) radiation detector units 210 extending along the Z-axis dimension, where each radiation detector unit 210 includes a pair of radiation sensors 80 located adjacent to one another along the Φ direction and mounted over a common ASIC 130. Other suitable configurations for the detector modules 200 and/or radiation detector units 210 of the detector array 300 may also be utilized.

Radiation sensors 80 as described above are typically sourced from a wafer of a radiation-sensitive semiconductor material (e.g., CZT) that is singulated (i.e., diced) to provide a plurality of individual radiation sensors 80 or “tiles.” Accordingly, pixel detectors 126 located on the edges of the detector may be sensitive to defects created at the crystal (e.g., tile) edge during dicing. These defects may create increased surface currents that flow around the corners and edges of the detector tile and may increase charge generation, which can cause premature reverse breakdown in the detector tiles which are configured as Schottky diodes, as well as excess currents at operating voltages. Defects arising from cutting may also create a high-density of carrier traps with long de-trapping time and may result in ballistic deficit and reduction in charge collection efficiency of the edge pixel detectors 126. Defects arising from cutting or due to surface contamination may disturb the electric field in the sensor such that photo generated carriers are directed to an electrode that is not aligned with the location (voxel) where the radiation was absorbed.

Thus, the pixel detectors 126 along the peripheral edges of radiation sensors 80 tend to exhibit relatively poorer performance and reliability than the pixel detectors 126 located in the interior regions of the radiation sensors 80. The presence of these edge pixel detectors 126 may be particularly problematic for CT reconstruction because the image data is typically processed in “slices,” meaning that image data from each row of pixel detectors 126 located at the same position along the Z-axis direction may be processed together. Because the edge pixel detectors 126 in the detector array 300 shown in FIG. 5 are all aligned, this means that a number of rows in the detector array 300 are composed entirely of edge pixel detectors 126. One such edge pixel detector 126 row, n-x, where x is an integer less than n, is shown in FIG. 5. In the detector array 500 shown in FIG. 5, for example, sixteen (16) of the n rows of pixel detectors 126 are edge pixel detector rows made up entirely of relatively poor performing edge pixel detectors 126. Moreover, many of these edge pixel detector rows occur consecutively along the Z-axis direction between adjacent rows of radiation detector units 210, which may further negatively affect image quality.

It may be possible to improve the performance and reliability of edge pixel detectors 126 by providing a protective coating over the sidewalls of the radiation sensors 80. The protective coating may prevent defects on the sidewalls that reduce the performance and reliability of the edge pixel detectors. However, providing a protective coating over individual radiation sensors 80 can add complexity and cost to the manufacturing process. In particular, the handling of individual radiation sensors 80 can be challenging. The coating process may further require masking of both the cathode and anode electrode surfaces to prevent deposition and/or separate etching processes to remove the coating from select regions of the radiation sensors 80. The masking can be very difficult around edges and corners.

Various embodiments include using a conformal deposition process to form a protective coating over the side walls of the radiation sensors 80 after the radiation sensors 80 have been assembled into an above-described radiation detector unit 210. In accordance with various embodiments, one or more radiation sensors 80 may be mounted over the front side of an ASIC 130. The radiation sensors 80 may be mounted over the ASIC 130 via an interposer 40, such as shown in FIG. 3A, or via a direct attach method as shown in FIG. 3B. One or more ASICs 130 having radiation sensor(s) 80 mounted thereto may be provided on a carrier board 60 to provide a radiation detector unit 210. The assembled radiation detector unit 210 may be introduced into the reaction chamber of a conformal deposition system. In some embodiments, the conformal deposition system may be an atomic layer deposition (ALD) system. However, other suitable conformal deposition systems, such as a chemical vapor deposition (CVD) system may also be utilized. The deposition system may be used to conformally deposit a protective layer over exposed surfaces of the assembled radiation detector unit 210, including over sidewalls of the radiation sensors 80 of the radiation detector unit 210. In one embodiment, the protective layer may be deposited by ALD at a temperature of 200° C. or less, such as 100 to 200° C.

Various embodiments provide a straightforward and cost-effective method for providing a protective coating over the sidewalls of the radiation sensors 80 of a radiation detector unit 210. By forming the protective coating after the radiation detector unit 210 is assembled (e.g., after the radiation sensor 80 is electrically connected to the ASIC 130), additional handling and/or processing of the individual radiation sensors 80 may be avoided and standard assembly processes for the radiation detector unit 210 may be utilized. The assembled radiation detector units 210 may undergo testing/validation procedures prior to the coating process, such that only known good radiation detector units 210 may be coated. Because the radiation detector units 210 may be coated using a conformal deposition process, all exposed surfaces of the radiation detector units 210, such as surfaces of the carrier board 60, the ASIC 130, and the bonding material portions 82, 52, 192 (e.g., solder balls, conductive epoxy, etc.), may also be coated by the protective coating. The protective coating may be composed of a suitable electrically insulating material that does not interfere with or otherwise affect the functionality of these components. Furthermore, by performing the conformal coating process after the radiation detector units 210 are assembled, the requirements for masking portions of the radiation sensors 80 may be reduced. In some embodiments, only select regions of the radiation detector unit 210, such as the areas corresponding to the cathode electrode 122 and the connector for the radiation detector unit, may be masked.

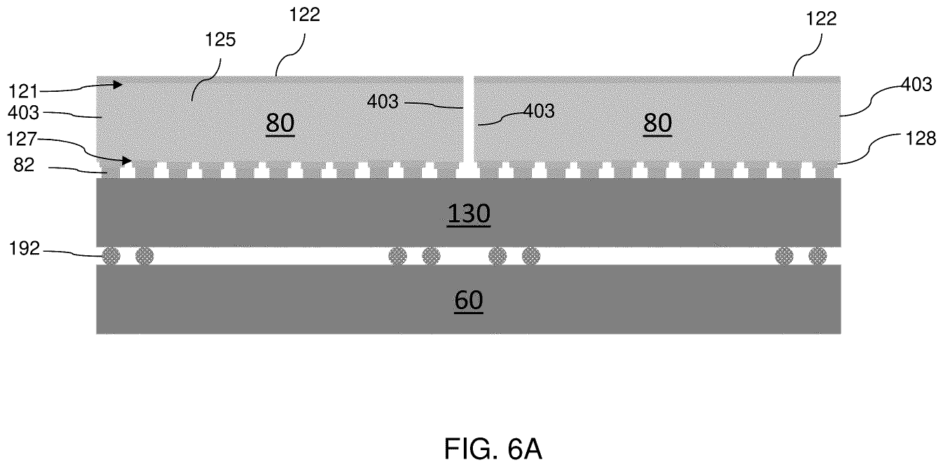

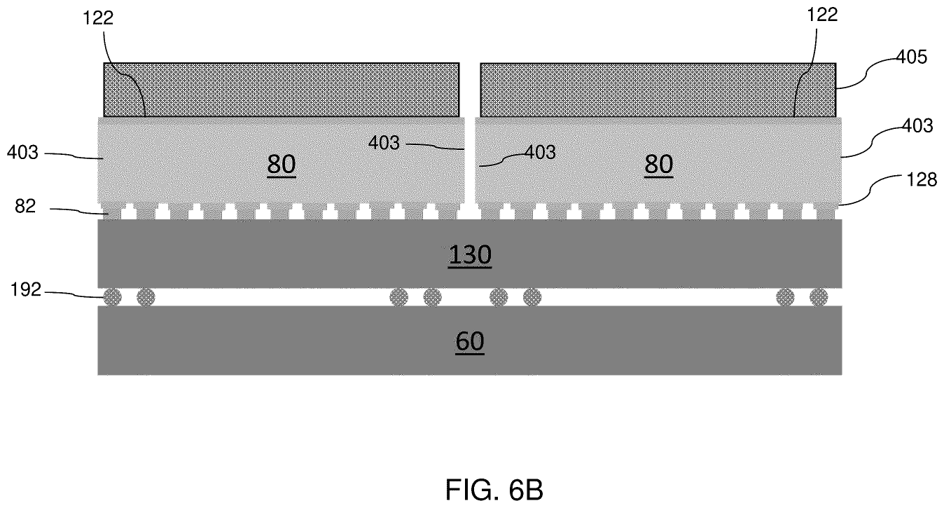

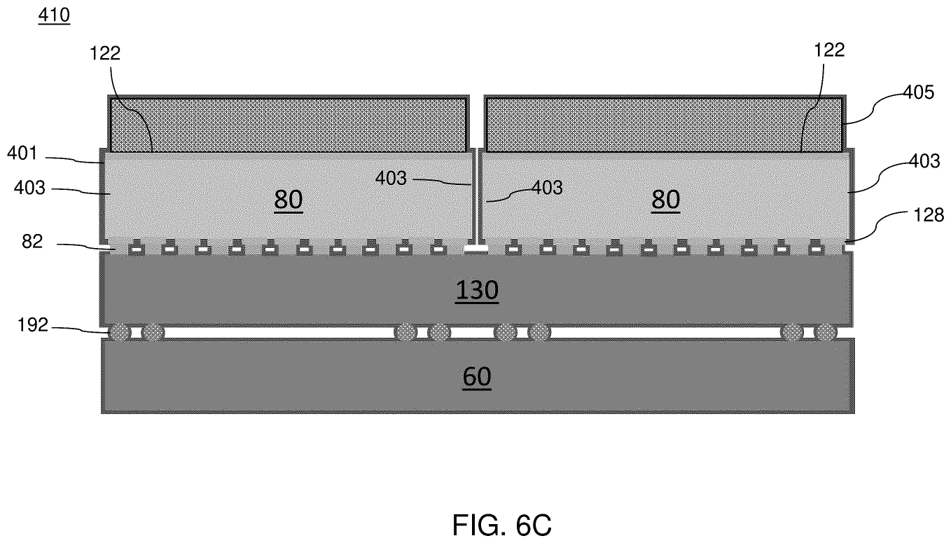

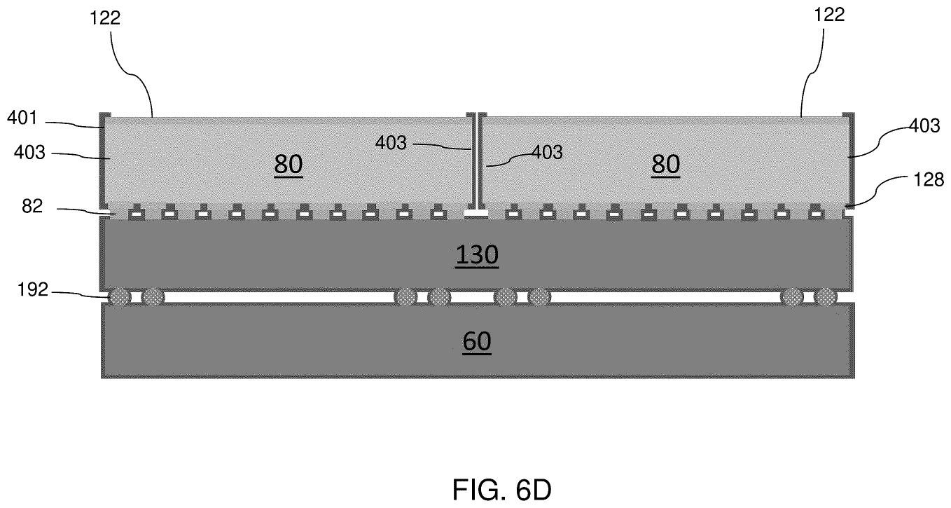

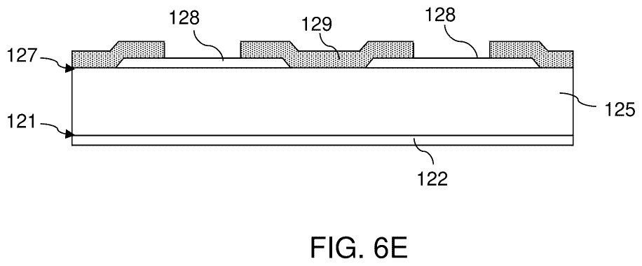

FIGS. 6A-6D are side cross-section views illustrating a process of forming a protective coating 401 over exposed surfaces of a radiation detector unit 210, including over the sidewalls 403 of the radiation sensors 80 according to various embodiments of the present disclosure. Referring to FIG. 6A, an above-described radiation detector unit 210 including a carrier board 60, an ASIC 130 mounted over the front side of the carrier board 60, and a plurality of radiation sensors 80 mounted over the front side of the ASIC 130 is illustrated. Each radiation sensor 80 includes a front (i.e., top) side 121 containing the cathode electrode 122 thereon, and a back (i.e., bottom) side 127 facing the ASIC and containing a plurality of anode electrodes 128 thereon. Although the radiation detector unit 210 of FIG. 6A is a “direct attach” type radiation detector unit 210 that does not include an interposer 40 located between the radiation sensors 80 and the ASIC 130, it will be understood that the process steps shown in FIGS. 6A-6D may also be utilized for a radiation detector unit 210 that includes an interposer 40 shown in FIG. 3A. As shown in FIG. 6A, the radiation sensors 80 of the radiation detector unit 210 may have exposed sidewalls 403 around the periphery of the radiation sensors 80. In one embodiment shown in FIG. 6E, the radiation sensor 80 may include an anode encapsulation layer 129 that partially covers the metal regions of the pixels (i.e., the edge portions of the anode electrodes 128) and covers the region (e.g., “streets”) between the metal regions (i.e., the anode electrodes 128) of the pixels. This anode encapsulation 129 layer may be 1 nm to 5 microns thick and may be made from any suitable insulating organic or inorganic materials.

FIG. 6B is a side cross-section view of the radiation detector unit 210 with a mask 405 formed or positioned over select portions of the radiation detector unit 210 according to various embodiments of the present disclosure. Referring to FIG. 6B, the mask 405 may provide a physical barrier between select surface region(s) of the radiation detector unit 210 and process gas(es) used during a subsequent deposition process such that a protective coating 401 is prevented from forming over the region(s) protected by the mask 405. In some embodiments, the radiation detector unit 210 may be provided on a fixture or have tape attached that may be configured to physically block certain surface region(s) of the radiation detector unit 210 from being exposed to process gas(es) during the subsequent deposition step. In other embodiments, an organic mask layer, such an epoxy or polymer material, may be deposited over the cathode electrodes 122 and the connector for the cable assembly 62 to form the mask 405. For example, the mask 405 may be a photolithographically-formed mask 405 that may be formed by depositing a photosensitive material (e.g., a photoresist) over the radiation detector structure 210 and exposing select portions of the photosensitive material to radiation through a patterned mask such that the portions of the photosensitive material that are exposed to the radiation become either more or less soluble than the unexposed portions of the photosensitive material. Then, a development process may be utilized to remove the relatively more soluble portions of the photosensitive material, leaving a patterned mask 405 over select regions of the radiation detector structure 210 as shown in FIG. 6B. It will be understood that other suitable techniques for providing a mask 405 as shown in FIG. 6B may also be utilized.

Referring again to FIG. 6B, in various embodiments, the mask 405 may be located over the cathode electrodes 122 of each of the radiation sensors 80 of the radiation detector unit 210. The mask 405 may also cover other regions of the radiation detector unit 210, such as the connector for an above-described cable assembly 62 that may be utilized for transmission of power and data signals to and from radiation detector unit 210 in an assembled detector module 200 and/or detector array 300.

FIG. 6C is a side cross-section view of the radiation detector unit 210 with a protective coating 401 deposited over exposed surfaces of a radiation detector unit 210 according to various embodiments of the present disclosure. Referring to FIG. 6C, the radiation detector unit 210 may be provided within the reaction chamber 410 of a conformal deposition system. In some embodiments, the conformal deposition system may be an atomic layer deposition (ALD) system. Other suitable conformal deposition systems may also be utilized. The deposition system may be operated to introduce one or more process gases, such as a sequence of ALD precursor pulses, into the reaction chamber 410. The process gases introduced into the reaction chamber 410 may react to deposit a protective coating 401 over exposed surfaces of the radiation detector unit 210. In various embodiments, the protective coating 401 may be conformally deposited over all surfaces of the radiation detector unit 210 that are not covered by the mask 405 or are not otherwise physically shielded from the process gases. As shown in FIG. 6C, for example, the protective coating 401 may be deposited over the sidewalls 403 and lower surfaces of the radiation sensors 80, over external portions of the anode electrodes 128, the bonding material portions 82 between the anode electrodes 128 and the ASIC 130, the upper, lower and side surfaces of the ASIC 130, the bonding material portions 192 between the ASIC 130 and the carrier board 60, and the upper, lower and side surfaces of the carrier board 60. In embodiments in which a mask 405 is provided over the cathode electrodes 122, the protective coating 401 may also be formed over the mask 405. If the anode encapsulation layer 129 is located over the backside of the radiation sensor 80, then the protective coating 401 may be formed over the anode encapsulation layer.

In various embodiments, the protective coating 401 may be formed of a suitable electrically insulating material. In some embodiments, the protective coating 401 may be composed of one or more inorganic materials (i.e., a material that does not include carbon-hydrogen bonds). In one non-limiting embodiment, the protective coating 401 may include aluminum oxide (Al₂O₃) or titanium oxide (TiO₂), or mixtures (e.g., aluminum titanium oxide) or nanolaminates thereof. Other suitable materials, such as any insulating metal oxide, metal nitride or metal sulfide, or semiconductor oxide or nitride (e.g., silicon oxide, germanium oxide, silicon nitride or germanium nitride) or mixtures (yttrium zirconium oxide, silicon oxynitride, etc.) or nanolaminates thereof may be used. For example, insulating materials include scandia, yttria, zirconia, hafnia, niobium oxide, tantalum oxide, aluminum nitride, etc. As used herein, a nanolaminate includes at least two insulating layers having different compositions from each other and thicknesses of 10 nm or less, such as 0.4 to 5 nm each.

Other suitable materials for the protective coating 401 are within the contemplated scope of the disclosure. In various embodiments, the protective coating 401 may have a thickness of 150 nm or less, such as between about 2 nm and about 100 nm (e.g., 40-60 nm), including about 50 nm. In some embodiments, the deposition of the protective coating 401 may be performed at a temperature that is less than about 200° C., such as between about 20° C. and about 150° C., to avoid damaging the carrier board 60. In other embodiments, the deposition may be performed at a higher temperature. Preferably, the deposition temperature is below a temperature at which the carrier board 60 is damaged and/or the solder balls are reflowed.

FIG. 6D is a side cross-section view of the radiation detector unit 210 with a protective coating 401 following the removal of the mask 405 according to various embodiments of the present disclosure. Referring to FIG. 6D, the radiation detector unit 210 may be removed from the reaction chamber 410 of the deposition system. In embodiments in which a mask 405 is utilized, the mask 405 may be removed via a suitable process, such as by selective dissolution with a solvent. In some embodiments, a liftoff process may be utilized to remove the mask 405 in addition to any of the protective coating 401 that is deposited over the mask 405. As shown in FIG. 6D, select regions of the radiation detector unit 210, including the cathode electrodes 122 and optionally connector(s) 62 for a cable assembly (not shown in FIG. 6D), may be exposed through openings the protective coating 401 (i.e., are not covered by the protective coating). In various embodiments, portion(s) of the radiation detector unit 210 may be exposed through the openings in the protective coating 401 without requiring an etching process to etch portions of the protective coating 401.

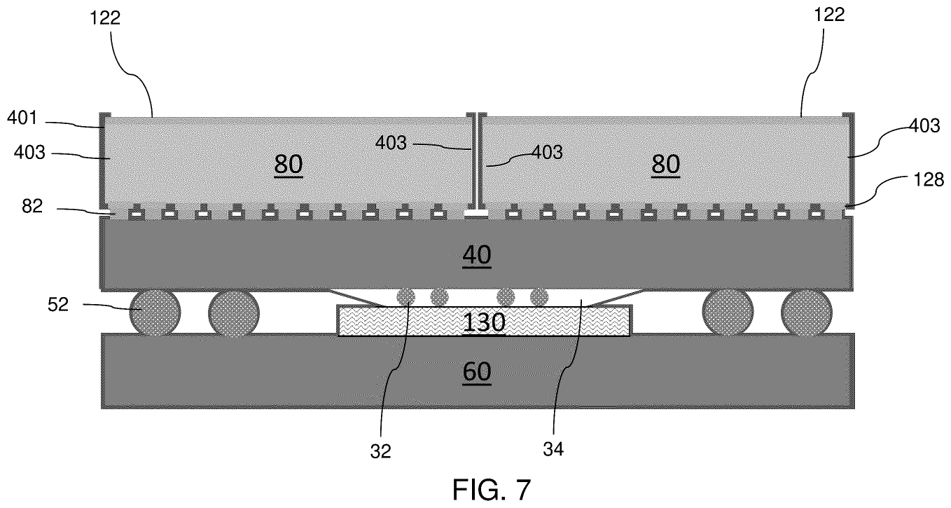

FIG. 7 is a side cross-section view of the radiation detector unit 210 with a protective coating 401 according to another embodiment of the present disclosure. The radiation detector unit 210 shown in FIG. 7 may be similar to the radiation detector unit 210 described above with reference to FIG. 3A. In particular, the radiation detector unit 210 may include an interposer 40 located between the radiation sensors 80 and an ASIC 130 as described above with reference to FIG. 3A. The assembled radiation detector unit 210 may be placed in a reaction chamber of a conformal deposition system as described above, and a protective coating 401 may be formed over exposed surfaces of the radiation detector unit 210. In the embodiment shown in FIG. 7, the protective coating 401 may be deposited over the sidewalls 403 and lower surfaces of the radiation sensors 80, over portions of the anode electrodes 128, the bonding material portions 82 between the anode electrodes 128 and the interposer 40, the upper, lower and side surfaces of the interposer 40, the upper and side surfaces of the ASIC 130, the solder balls 52 extending between the interposer 40 and the carrier board 60, and the upper, lower and side surfaces of the carrier board 60. In the embodiment, an insulating matrix 34 may be located around the array of first bonding structures 32 between the interposer 40 and the ASIC 130. The protective coating 401 may be located over the surface of the insulating matrix 34.

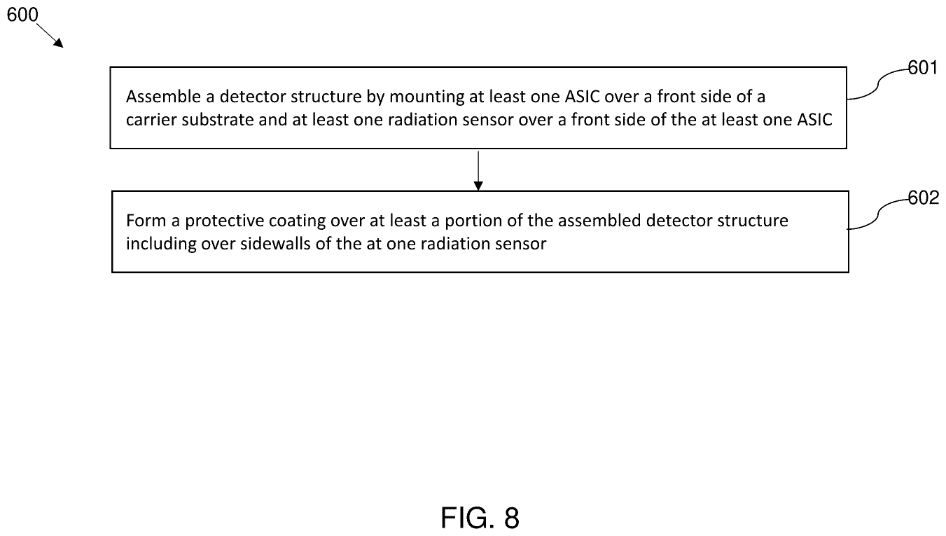

FIG. 8 is a flow diagram illustrating a method 600 of fabricating a detector structure, such as an above-described radiation detector unit 210, according to various embodiments of the present disclosure. In step 601 of method 600, a detector structure 210 may be assembled by mounting at least one ASIC 130 over the front side of a carrier substrate 60 and at least one radiation sensor 80 over the front side of the at least one ASIC 130. In step 602 of method 600, a protective coating 401 may be formed over at least a portion of the assembled detector structure 210 including over sidewalls of the at least one radiation sensor 80.

The devices of the embodiments of the present disclosure can be employed in various radiation detection systems including computed tomography (CT) imaging systems. Any direct conversion radiation sensors may be employed such as radiation sensors employing Si, Ge, GaAs, CdTe, CdZnTe, and/or other similar semiconductor materials.

The radiation detectors of the present embodiments may be used for medical imaging as radiation detectors in High-Flux applications as in X-ray Computed Tomography (CT) for medical applications, and for non-medical imaging applications, such as in baggage security scanning and industrial inspection applications.

While the disclosure has been described in terms of specific embodiments, it is evident in view of the foregoing description that numerous alternatives, modifications and variations will be apparent to those skilled in the art. Each of the embodiments described herein can be implemented individually or in combination with any other embodiment unless expressly stated otherwise or clearly incompatible. Accordingly, the disclosure is intended to encompass all such alternatives, modifications and variations which fall within the scope and spirit of the disclosure and the following claims.

1. A detector structure, comprising:
a carrier board;
at least one application specific integrated circuit (ASIC) located over the carrier board, the at least one ASIC comprising signal processing channel circuitry;
at least one radiation sensor located over a front side of the at least one ASIC, the at least one radiation sensor having a front side and a back side, wherein the back side of the at least one radiation sensor faces the front side of the at least one ASIC; and
a protective coating located over sidewalls and at least a portion of the back side of the at least one radiation sensor and over at least a portion of the at least one ASIC and over at least a portion of the carrier board.

2. The detector structure of claim 1, wherein the protective coating has a thickness between 2 nm and 100 nm.

3. The detector structure of claim 2, wherein the protective coating has a thickness between 40 nm and 60 nm.

4. The detector structure of claim 1, wherein the protective coating comprises an inorganic material.

5. The detector structure of claim 4, wherein the protective coating comprises an insulating metal oxide, metal nitride, metal sulfide, semiconductor oxide or semiconductor nitride, or mixtures or nanolaminates thereof.

6. The detector structure of claim 5, wherein the protective coating comprises aluminum oxide or titanium oxide or a mixture or a nanolaminate thereof.

7. The detector structure of claim 1, wherein each radiation sensor comprises a cathode electrode on a front side of the radiation sensor, wherein the cathode electrode is exposed through an opening in the protective coating.

8. The detector structure of claim 7, wherein each radiation sensor comprises a plurality of anode electrodes on a back side of the radiation sensor, wherein the protective coating is located over a portion of each anode electrode.

9. The detector structure of claim 7, further comprising a plurality of first bonding material portions located between anode electrodes of the at least one radiation sensor and the at least one ASIC, wherein the protective coating is located over a portion of the first bonding material portions.

10. The detector structure of claim 7, further comprising a plurality of second bonding material portions located between the at least one ASIC and the carrier board, wherein the protective coating is located over a portion of the second bonding material portions.

11. The detector structure of claim 1, wherein the at least one radiation sensor comprises cadmium zinc telluride or cadmium telluride.

12. The detector structure of claim 1, wherein the front side of the at least one ASIC is bonded to the back side of the at least one radiation sensor.

13. The detector structure of claim 1, further comprising at least one interposer located between the front side of the at least one ASIC and the bottom side of the at least one radiation sensor.

14. An X-ray imaging system, comprising:
a radiation source configured to emit X-rays; and
a detector array including a plurality of detector structures of claim 1 that form a continuous detector surface and that are configured to receive the X-rays from the radiation source through an intervening space configured to contain an object therein.

15. A method of fabricating a detector structure, comprising:
assembling a detector structure by mounting at least one application-specific integrated circuit (ASIC) over a front side of a carrier substrate and at least one radiation sensor over a front side of the at least one ASIC; and
forming a protective coating over at least a portion of the assembled detector structure including over sidewalls of the at least one radiation sensor.

16. The method of claim 15, wherein the step of forming the protective coating comprises placing the assembled detector structure within a reaction chamber of a deposition apparatus after the step of assembling the detector structure, and introducing one or more process gasses into the reaction chamber to conformally deposit the protective coating over exposed surfaces of the assembled detector structure.

17. The method of claim 16, wherein the protective coating comprises an inorganic protective coating that is formed via atomic layer deposition (ALD) at a temperature of less than 200° C.

18. The method of claim 15, further comprising providing a physical barrier over one or more select portions of the detector structure to prevent deposition of the protective coating over the one or more select portions of the radiation structure.

19. The method of claim 18, wherein providing the physical barrier comprises forming a mask over the one or more select portions of the radiation structure.

20. The method of claim 18, wherein the one or more select portions of the detector structure comprises at least one cathode electrode on a front side of the at least one radiation sensor.

21. The method of claim 18, wherein the one or more select portions of the detector structure comprises at least one connector for a cable assembly.

22. The method of claim 15, wherein the protective coating comprises an insulating metal oxide, metal nitride, metal sulfide, semiconductor oxide or semiconductor nitride, or mixtures or nanolaminates thereof.

23. The method of claim 22, wherein the protective coating comprises aluminum oxide or titanium oxide, or mixture or nanolaminate thereof.
